(19) United States
(12) Patent Application Publication
(10) Pub. No.: US 2026/0051956 A1
(43) Pub. Date: Feb. 19, 2026

(54) SYSTEM AND METHOD FOR NONORTHOGONAL MODULATION

(71) Applicant: NOKIA SOLUTIONS AND NETWORKS OY, Espoo (FI)

(72) Inventors: Robert Borkowski, Murray Hill, NJ (US); Kovendhan Vijayan, Edison, NJ (US)

(21) Appl. No.: 18/804,736

(22) Filed: Aug. 14, 2024

(51) Int. Cl. H04B 10/516; H04B 10/61; H04Q 11/00

(52) U.S. Cl. CPC H04B 10/516; H04B 10/61; H04Q 11/0067

(57) ABSTRACT

Systems and methods for power budgeting within a coherent optical network are provided. A phase shift controller may be provided for controlling a phase shift (θ) between an in-phase (I) and quadrature (Q) branches of an optical IQ modulator to generate a complex IQ signal. The phase shift of the optical IQ modulator may be controlled between an orthogonal mode, such as a conventional QPSK mode, and a nonorthogonal mode, based on an operational state of the modulator. The nonorthogonal mode may include a high-suppression mode and a high-power mode.

The present invention relates to the field of passive optical networks, and particularly, to coherent passive optical networks, and more particularly to nonorthogonal modulation of an optical signal.

### BACKGROUND

Passive optical networks (PONs) provide broadband access. PON's may have a point-to-multi-point (P2MP) topology, in which one optical line terminal (OLT) at the network side (sometimes the network side is called the “central office”) is used to connect to a multitude (e.g., 32 or 64) of optical network units (ONUs) at the user side by means of an optical distribution network (ODN), or fiber plant that contains optical fibers and passive optical splitters, but usually no active components.

FIG. 1A illustrates an exemplary physical layer topology of a PON system 100. The system includes an OLT 102 coupled via an optical network 104 with a splitter 106, coupled with a plurality of ONU's 108 via splitters 106. As shown, an active ONU 108a is in a transmitter on-state, while the other ONUs are inactive (transmitters are in a transmitter off-state). It should be understood that in this example, only one ONU is shown as active, but more than one may be active. What is important is the view point of the OLT 102 and the timing of signals from the ONUs received. Not shown, a series of other passive network elements such as fibers, splitters, wavelength multiplexers, wavelength filters, etc. may be used to connect the plurality of ONUs 108 with the OLT 102.

In order to share the available spectrum of the fiber medium, most PON technologies, such as G-PON, E-PON, and XGS-PON, utilize time-division multiplexing (TDM) scheme or technique, in which the fiber medium is shared in the time domain between the different ONUs. In the downstream (DS) direction (i.e., transmission from network side to the user side (OLT to the ONUs)), the signal is continuously broadcasted from the OLT to all ONUs. In the upstream (US) direction (i.e., transmission from user side to the network side (ONUs to OLT)), a time-division multiple-access (TDMA) scheme, also known as burst-mode (BM) operation is employed, in which ONUs sends burst signals that, at the receiver (e.g., OLT), do not overlap in time with bursts from other ONUs. This mode of operation implies that only one ONU is transmitting in the upstream direction in each timeslot, like shown in FIG. 1A. The remaining ONUs remain silent for the duration of the active ONUs timeslot. It will be understood, however, that if fiber length for different ONUs is different, and thus propagation time is also different, it may be possible and necessary that some bursts from a number of different ONUs may actually need to be emitted at the same or similar time instant. But due to difference in propagation time they will not overlap when arriving at the OLT receiver. The upstream bursts are usually created by bursting the bias of the distributed feedback (DFB) laser.

It is well known from existing PON generations that non-transmitting ONUs may emit residual optical noise. This is usually called “when not enabled” (WNE) power and is often characterized by the maximum allowable “when not enabled” power spectral density (WNE-PSD). Given the large dynamic range of PONs (≥15 dB), WNE power from off-state transmitters (ONUs) can be a significant source of interference into the band of the transmitting ONU, effectively decreasing the number of ONUs that can be connected to a single PON (since more inactive ONUs=more crosstalk). This is shown in FIG. 1B. Again, FIG. 1B is merely a theoretical example and more than one ONU may actually transmit at a time, but at the network side, signals from the ONUs will not overlap.

In FIG. 1B, it is illustrated how four ONU's operating in burst-mode 110a, 112a, 114a, 116a, 110b, 112b, 114b and 116b generate optical power during bursts over time, but horizontal lines 110c, 112c, 114c, and 116c show off-state noise from inactive ONU's. Accumulated off-state noise is shown by line 118.

For that reason, the WNE level was standardized, such that even for the worst-case transmitting ONU (the non-transmitting ONUs have 15 dB less loss compared to the transmitting ONU), the amount of crosstalk is still manageable. The worst-case transmitting ONU can be defined as the ONU with the lowest optical power in the view of the OLT receiver. The lowest power is just an example. However, there is also an aspect of “signal quality” (signal integrity) that can be considered. This problem is known as upstream noise accumulation.

Recently, coherent technology is considered as potential candidate for realization of high-speed future generation PON. Coherent technology is commercially applied for long-haul, metro and intra-datacenter systems. However, application in PON brings new and unexplored aspects. Coherent PON also enables the use of digital subcarriers, adding another dimension for multiplexing the different ONUs. Such PON systems may use time-frequency division multiple access (TFDMA) in the upstream direction.

FIG. 2 is a schematic of an optical IQ modulator. Two inner Mach-Zender modulators (MZM) 202a,b may be used to modulate data corresponding to the in-phase (I) and quadrature (Q), which are then combined with a phase offset 204 corresponding to phase (θ) in the outer MZM 206. For normal IQ operation, the phase shift between the in-phase (I) and quadrature (Q) branches is always orthogonal, i.e. set to 90°, i.e., phase θ=90° (in general, θ=k·180°+90° with k integer), to generate a complex IQ signal (constellation) representing data. By doing so, half the power is lost during the summation of signals from both branches, which corresponds to the IQ modulator having an intrinsic loss of 3 dB.

There are at least two technical challenges in coherent PON that the invention addresses.

First, high residual carrier power in the transmitter off-state. As described above, in conventional IM/DD PON, the transmitter output is usually suppressed by turning off the laser during the transmitter off-state. This is why in IM/DD, burst-mode operation can easily be used to realize PON upstream. Unfortunately, for coherent PON, the laser cannot be easily disabled for a number of reasons.

Coherent receivers are sensitive to phase noise of the laser source. Thus, instead of a DFB, a more complicated type of laser—external cavity laser (ECL)—is usually used. This type of laser cannot be easily switched off on a burst basis because of their longer settling time in seconds. See Optoplex, TL-MC040TA101 tunable laser data sheet, available at https://optoplex.com/download/Optoplex % 20Tunable %20Laser %20Brochure %20Rev1.2_2017. pdf, which cites Cold Start Settle Time of 10 s, and Warm Start Settle Time of 0.1 s, which are orders of magnitude higher than typical PON burst durations on the order of microseconds.

Second, due to the use of a local oscillator, coherent receivers require short- and long-term stability of the transmit laser. Meanwhile, bursting the laser results in a thermal chirp (optical frequency drift induced by a change of carrier density and thus a refractive index of the cavity), which may range as much as 100 s of GHz and last microseconds. This may render use of DFB lasers as sources for burst-mode coherent transmitters infeasible.

For most of the existing IM/DD PON implementations, the problems listed above were irrelevant since direct detection is not sensitive to optical frequency (wavelength). However, these problems are crucial for coherent PON, which also use frequency to discriminate a signal.

For coherent PON, one possible solution to avoid direct bursting of the transmit laser is to transmit null symbols using the conventional IQ modulator. This is illustrated in the left side of FIG. 3, showing a null symbol during transmitter off-state/burst disabled state. This solution has been described in e.g., H. Zhang, Z. Jia, L. A. Campos and C. Knittle, “Experimental Demonstration of Rate-Flexible Coherent PON Up to 300 Gb/s,” in Journal of Lightwave Technology, doi: 10.1109/JLT.2024.3366163. However, experimental measurements show that the residual power suppression obtained this way is limited. This is shown on the right side of FIG. 3 illustrating presence of residual carrier power even during the transmitter off-state, and also is confirmed by the specification contained in the 100GBASE-ZR (IEEE 802.3ct) standard, which mandates integrated launch power in transmitter off-state to be ≤−35 dBm [“IEEE Standard for Ethernet Amendment 13: Physical Layers and Management Parameters for 100 Gb/s Operation over DWDM Systems,” in IEEE Std 802.3ct-2021 (Amendment to IEEE Std 802.3-2018 as amended by IEEE's 802.3cb-2018, 802.3bt-2018, 802.3cd-2018, 802.3cn-2019, 802.3cg-2019, 802.3cq-2020, 802.3 cm-2020, 802.3ch-2020,802.3ca-2020, 802.3cr-2021, 802.3cu-2021, and 802.3cv-2021), vol., no., pp. 1-133, Jul. 9, 2021, doi: 10.1109/IEEESTD.2021.9497042.].

Another proposed solution is an optical shutter, or optical gate, external to the laser and modulator. Such optical shutter toggles transmitter power just after the output of the transmitter, allowing for the operation of all prior subsystems in continuous mode. An external shutter may be implemented as a semiconductor optical amplifier (SOA) or a fast variable optical attenuator (VOA). However, such a shutter constitutes an additional cost and requires integration.

Thus, there is a need for improving the intrinsic suppression achieved by the IQ modulator itself.

Another problem in the art is the limited power budget of a coherent PON. Coherent receivers use a local oscillator, which effectively acts as an amplifier for the incoming signal. For this reason, coherent receivers usually exhibit significantly better sensitivity than direct detection receivers (e.g., ˜10 dB comparing at the same modulation order and same symbol rate per photodetector). Nonetheless, an IQ modulator used for coherent systems usually exhibits higher losses due to excess loss (imperfections in a more complicated structure lead to overall higher loss). On the other hand, intensity modulation (IM) transmitters such as directly modulated lasers (DMLs) or electroabsorption-modulated lasers (EMLs) commonly used for intensity modulation, have significantly lower intrinsic losses. For this reason, the effective power budget, calculated as (Transmit Power-Receiver Sensitivity) for a coherent PON is comparable or even worse than for conventional IM/DD PON.

Thus, there is a need for an increase in optical power that can be achieved at the coherent transmitter side, as it may remove the need for higher-power laser sources or optical amplification.

### SUMMARY OF THE INVENTION

The scope of protection sought for various embodiments of the invention is set out by the independent claims. The embodiments and features, if any, described in this Specification that do not fall under the scope of the independent claims are to be interpreted as examples useful for understanding various embodiments of the invention.

According to embodiments of the present invention, a system for coherent optical communication may include an IQ modulator coupled with a controller, wherein the controller is configure to adjust the phase shift of the IQ modulator between an orthogonal mode and a nonorthogonal mode.

According to embodiments of the present invention, an apparatus, includes an optical IQ modulator configured to generate a complex IQ signal and a controller coupled with the optical IQ modulator. The controller is adapted to control the phase shift (θ) between the in-phase (I) and quadrature (Q) branches of the generated complex IQ signal. The controller may be adapted to control the phase shift of the optical IQ modulator between a conventional, orthogonal mode and a nonorthogonal mode based on an operational state of the optical IQ modulator.

According to embodiments of the present invention, the nonorthogonal mode includes at least one of a high-power mode and a high-suppression mode.

According to embodiments of the present invention, the phase shift (θ) between the I and Q branches of said optical IQ modulator is 0 degrees) (θ=0° in said high-power mode and 180 degrees) (θ=±180° in said high-suppression mode.

If 90°<θ<270° (or −90°<θ<−270°, the term will be negative, thus the optical power is decreased. Specifically, for θ=180°, the power is nulled, while, for θ=0°, the power is doubled. These ranges may be generalized to higher orders; they can be periodic with a period of 360°.

According to embodiments of the present invention, the optical IQ modulator may be a single-polarization or a dual-polarization optical IQ modulator.

According to embodiments of the present invention, the controller may be adapted to control the optical IQ modulator into the high-suppression mode during a transmitter off-state of the modulator and/or into one of an orthogonal mode and the high-power mode during a transmitter on-state of the modulator.

According to embodiments of the present invention, the controller may be adapted to control the optical IQ modulator into a quadrature mode in transmitter off-state and high-power mode in transmitter on-state.

According to embodiments of the present invention, the transmission through the modulator, normalized to transmission in a conventional operating point, is decreased in high-suppression mode, and increased when in high-power mode. According to embodiments of the present invention, the transmission through the modulator, normalized to transmission in a conventional operating point, is decreased by at least 10 dB in high-suppression mode, and increased at least 2 dB when in high-power mode.

According to embodiments of the present invention, the apparatus may be adapted to be implemented within an optical network unit (ONU) coupled with an optical line terminal (OLT) within a Time Division Multiple Access (TDMA) coherent passive optical network (PON), which may include TFDMA coherent PON. The controller may be adapted to receive control signals from said OLT and to control the optical IQ modulator the phase shift of the optical IQ modulator based on the received control signals.

According to embodiments of the present invention, the control signals may indicate the mode of the optical IQ modulator, e.g., orthogonal mode, high-suppression mode, and/or the high-power mode.

According to embodiments of the present invention, the coherent PON utilizes burst-mode transmission to realize upstream channel access and the controller controls the optical IQ modulator to said high-suppression mode is during a burst-disabled mode of the optical IQ modulator by modulating the phase shifter of the optical IQ modulator with a voltage signal synchronized with emission of bursts.

According to embodiments of the present invention, the apparatus may be adapted to be implemented within an optical line terminal (OLT) coupled with a plurality of optical network units (ONUs) within a Time Division Multiple Access (TDMA) coherent passive optical network (PON). The control unit may be adapted to control the optical IQ modulator the phase shift of the optical IQ modulator for downstream optical transmissions to the plurality of ONUs.

According to embodiments of the present invention, a method of power-budgeting within an optical network includes a step of controlling a phase shift (θ) between an in-phase (I) and quadrature (Q) branches of an optical IQ modulator to generate a complex IQ signal. The phase shift of the optical IQ modulator may be changed between an orthogonal mode and a nonorthogonal mode based on an operational state of the modulator.

According to embodiments of the present invention, the phase sift can be changed based on a required launch power and/or based on the tolerable crosstalk (the former for high-power mode and the latter for high-suppression mode).

According to embodiments of the present invention, the nonorthogonal mode may include at least one of a high-power mode and a high-suppression mode.

According to embodiments of the present invention, the phase shift (θ) between the I and Q branches of the optical IQ modulator is 0 degrees) (θ=0° in the high-power mode and/or 180 degrees (θ=+180° (or a multiple thereof) in the high-suppression mode.

According to embodiments of the present invention, the optical IQ modulator may be a single-polarization or a dual-polarization optical IQ modulator.

According to embodiments of the present invention, the controlling step controls the optical IQ modulator to the high-suppression mode during an off-state of the modulator and/or to one of an orthogonal mode and the high-power mode during an on-state of the modulator.

According to embodiments of the present invention, the transmission through the modulator, normalized to transmission in a conventional operating point, is decreased in the high-suppression mode, and increased in the high-power mode. According to embodiments of the present invention, the transmission through the modulator, normalized to transmission in a conventional operating point, is decreased by at least 10 db in high-suppression mode, and increased at least 2 dB when in high-power mode.

According to embodiments of the present invention, the method is performed within an optical network unit (ONU) coupled with an optical line terminal (OLT) within a Time Division Multiple Access (TDMA) coherent passive optical network (PON). The controlling step may be based on control signals received at the ONU, e.g., from the OLT.

According to embodiments of the present invention, control signals indicate the mode for the optical IQ modulator, e.g., orthogonal mode, the high-suppression mode, or the high-power mode.

According to embodiments of the present invention, the high-suppression mode is set during a burst-disabled mode.

According to embodiments of the present invention, the method is performed within an optical line terminal (OLT) coupled with a plurality of optical network units (ONUs) within a Time Division Multiple Access (TDMA) coherent passive optical network (PON). The controlling step controls the optical IQ modulator the phase shift of the optical IQ modulator for down-stream optical transmissions to the plurality of ONUs.

Other aspects in accordance with the invention will become apparent from the following detailed description, taken in conjunction with the accompanying drawings, illustrated by way of example of the principles of the invention.

### BRIEF DESCRIPTION OF DRAWINGS

Embodiments of the present invention are illustrated by way of example with reference to the accompanying drawings figures (FIGS. or FIGS.), which should not be construed to limit the present disclosure.

FIG. 1A is a Topology of a PON system with the active ONU (in on-state, marked in red) and multiple inactive ONUs transmitters (in off-state, marked in gray).

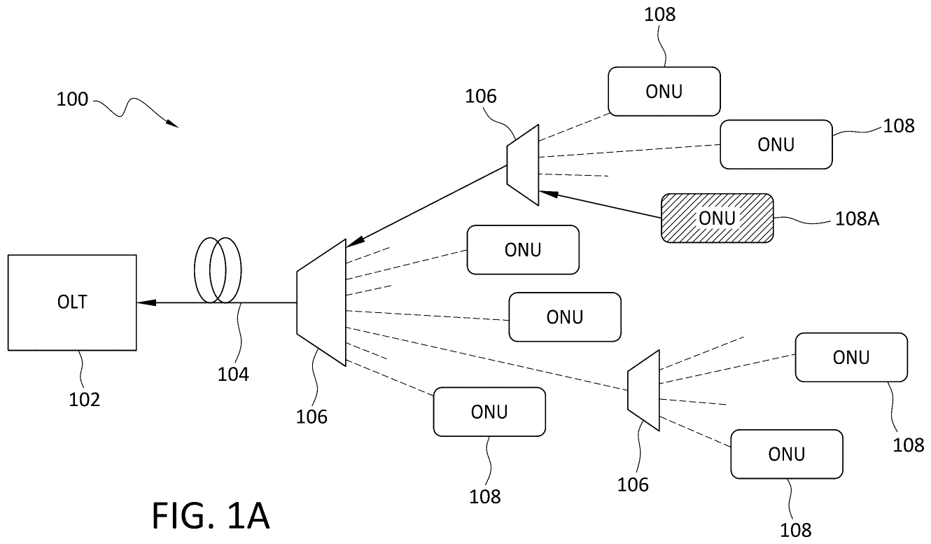

FIG. 1B is a graph illustrating Upstream noise accumulation.

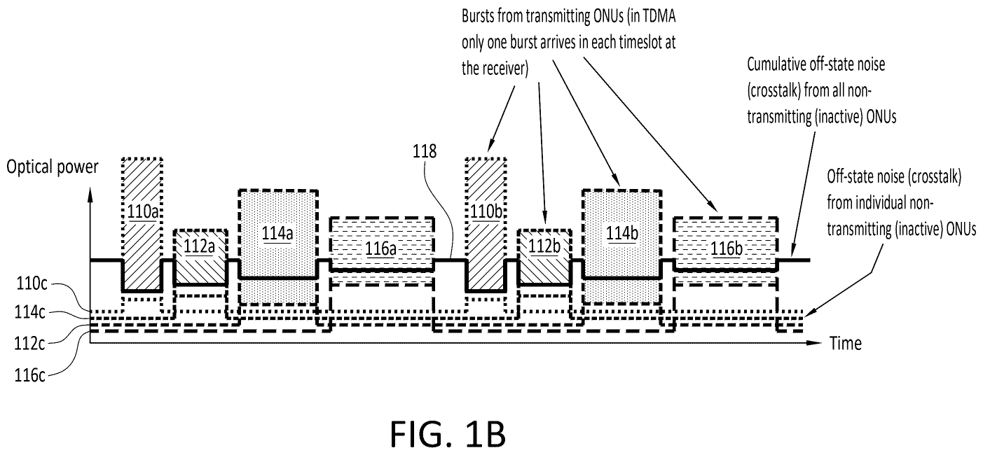

FIG. 2 is a schematic of an IQ modulator.

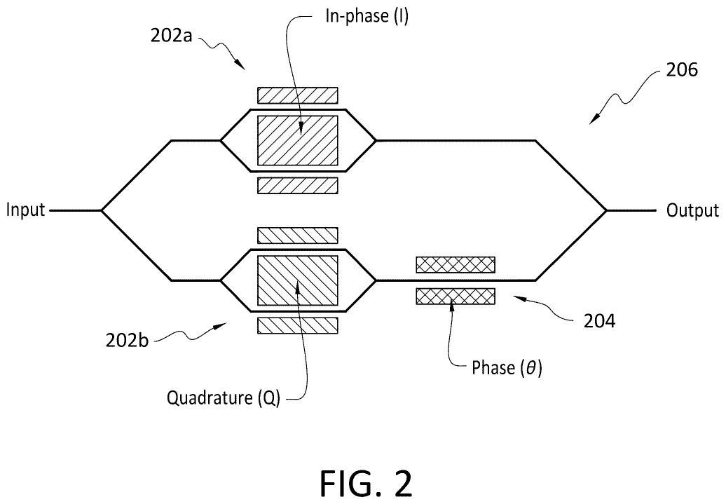

FIG. 3 is a graph illustrating measured spectra at the output of an IQ modulator according to embodiments of the present invention. The Tx off or burst disable (WNE) spectrum is the crosstalk emitted by not transmitting ONUs.

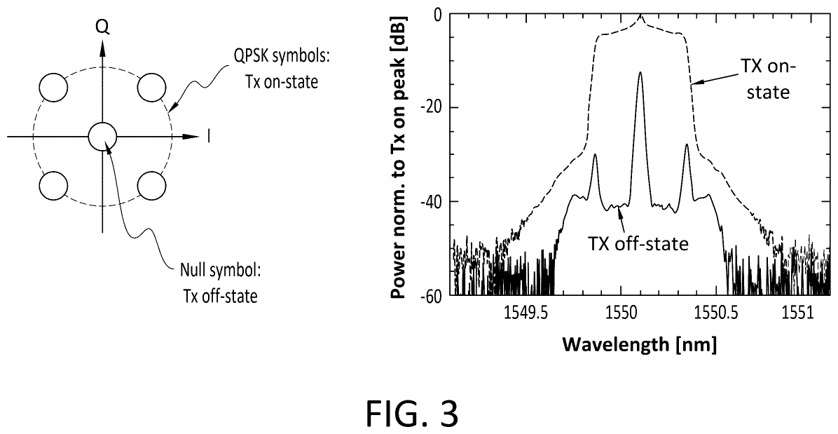

FIG. 4 is a schematic illustrating an IQ modulator with its inputs and outputs.

FIG. 5 is a diagram illustrating a conventional QAM-4 (aka QPSK) constellation generated in the conventional operating mode of the IQ modulator with mean power of 1²=1.

FIG. 6 is a diagram illustrating a conventional QAM-2 or (aka ASK-2 or sometimes incorrectly as BPSK) constellation generated in the conventional operating mode of the IQ modulator with mean power of 1²=1.

FIG. 7 is a diagram illustrating the high-suppression mode (I−Q) and high-power mode (I+Q) according to embodiments of the present invention.

FIG. 8 is a graph illustrating optical IQ modulator characteristic marking of different modes of operation according to embodiments of the present invention.

FIG. 9 is a diagram illustrating an example of a waveform that could be applied to a phase shifter of an IQ modulator for burst-mode operation and the resulting optical power generated from the transmitter according to embodiments of the present invention.

FIG. 10 is a diagram illustrating the number of ONUs supported in a TDMA coherent PON at a fixed sensitivity penalty (e.g. 2 dB considered), when non-transmitting ONUs are operated in the conventional mode versus a high-suppression mode according to embodiments of the present invention.

FIG. 11 is a diagram of example of a waveform that could be applied to a phase shifter of an IQ modulator for burst-mode operation, combining high-suppression mode for off-state and high-power mode for on-state, and the resulting optical power generated from the transmitter, according to embodiments of the present invention.

FIG. 12 shows examples of implementation of a phase shifter controller according to embodiments of the present invention.

FIG. 13 is a table summarizing observations and relations to the proposed new discrete operating modes according to embodiments of the present invention.

### DETAILED DESCRIPTION OF THE PREFERRED EMBODIMENTS

The following descriptions are presented to enable any person skilled in the art to create and use apparatuses, systems and methods described herein.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The present invention addresses problems in the prior art with power budgeting in a coherent PON including suppression of high residual carrier power in the transmitter off-state and improving optical power at the output of the coherent transmitter side.

According to embodiments of the present invention, two new modes of operation of an optical IQ modulator are provided: a high-suppression mode in which power at the output of the IQ modulator can be significantly reduced or suppressed during an off-state of the modulator (when transmitting null symbol); and a high-power mode in which the optical power at the output of the IQ modulator may be doubled (increased by 3 dB) in comparison to a conventional operating point of an IQ modulator.

In the context of this invention, in a dual-polarization optical IQ modulator, sometimes called a coherent modulator, each of the polarization is driven by a pair of single-polarization IQ modulators. Each of the polarizations can be driven by a single-polarization IQ modulator; or each of the polarizations can be driven by a pair of Mach-Zehnder modulators. Each inner IQ modulator can be considered independently.

According to embodiments of the invention, the high-suppression mode is particularly suitable for TDMA (or TFDMA) operation of coherent transmitters in a coherent PON. This mode allows a decrease in the transmit power from the non-transmitting ONUs during the burst-off state by multiple dBs. More than 10 dB is possible. As a result, crosstalk from non-transmitting ONUs to the transmitting ONU (or ONUs for TFDMA) can be significantly reduced. Lower crosstalk from each ONU effectively allows for many more ONUs to be connected to the same PON, since any receiver sensitivity penalty due to crosstalk depends on the total crosstalk from all connected ONUs in off-state. Also, any potential external optical shutters (e.g., implemented using SOAs or VOAs) may not be required if the crosstalk can be suppressed using the IQ modulator itself.

According to embodiments of the invention, the high-power mode increases power by removing the intrinsic loss of the conventional IQ modulator at the expense of system throughput, since the I and Q branches must be made non-orthogonal. Assume, for example, that modulation type for I and Q branches has not been adapted, and is the same as for orthogonal modulation. Because in non-orthogonal mode I and Q branches must be driven with the same waveforms, while in orthogonal mode I and Q waveforms can be different. But if we allow to change the modulation type driving I and Q branches, e.g., instead of two different 2-level signals, per I and Q, it can be changed to a single 4-level signal driving simultaneously I and Q branches, and there will be no impact on system throughput.

The high-power made can improve the power budget of the coherent PON without changing the laser power or without the use of optical amplifiers. In contrast, the naive approach of sending the same data in both the I and Q components of an IQ modulator, does not result in a power advantage. Only the present invention can provide this power advantage, which may result in a physical increase of the optical power by 3 dB (as measured with a power meter at the output of the IQ modulator).

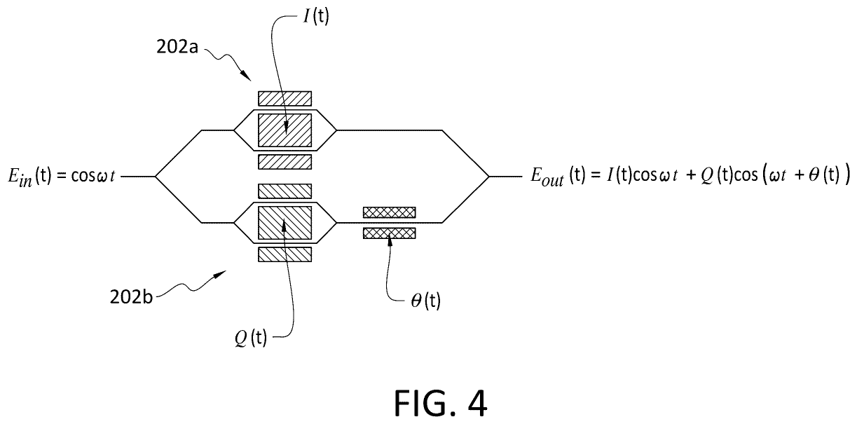

Referring to FIG. 4, for simplicity, the explicit dependency of the variables on time t is dropped. The input optical field to the IQ modulator is, as shown in FIG. 4, Eᵢₙ=cos ωt. Compute power of the signal at the output of the IQ modulator after modulation with signals/and Q can be computed as follows:

$${P}_{out} = E [ {E}_{out}^{2} ( t ) ] = E [ {\{ I cos ω t + Q cos ( ω t + θ ) \}}^{2} ] = E [ \{ {I}^{2} {cos}^{2} ω t + {Q}^{2} {cos}^{2} ( ω t + θ ) + 2 IQ cos ω t cos ( ω t + θ ) ] = E [ {I}^{2} ] E [ \frac{1 + cos 2 ω t}{2} ] + E [ {Q}^{2} ] E [ \frac{1 + cos ( 2 ω t + θ )}{2} ] = 2 E [ IQ ] E [ \frac{cos ( 2 ω t + θ ) + cos θ}{2} ] = \frac{E [ {I}^{2} ] + E [ {Q}^{2} ]}{2} + E [ IQ ] cos θ$$

where E[·] represents expectation operator (mean).

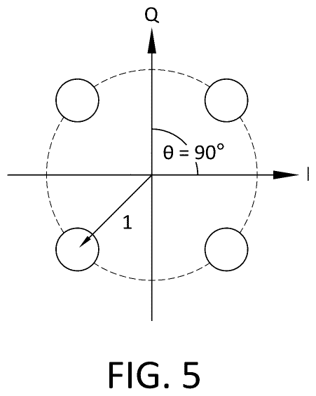

Under normal operation with two different I and Q signals, the corresponding constellation is shown in FIG. 5 for two-level bipolar inputs I and Q. The term E[IQ] cos θ will be zero because/and Q are uncorrelated zero-mean variables and thus E[IQ]=0.

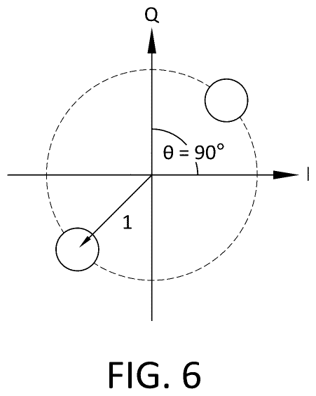

If I and Q data are the same, as shown in FIG. 6, the E[IQ] cos θ term will still remain zero, because although E[IQ]≠0 due to data correlation, cos(θ=) 90°=0. This also explains why a naïve approach of transmitting correlated data on I and Q does not lead to power increase. This is shown in FIG. 6, where points of the BPSK constellation are simply a subset of the points of QAM-4 constellation shown in FIG. 5 and are transmitted with no change in power.

However, if I and Q are correlated and cos(θ≠90°)≠0, E[IQ] cos θ becomes nonzero. As can be seen from the equation, this term can directly affect the optical power. If −90°<θ<90°, the term will be positive, thus the optical power is increased. If 90°<θ<270° (or −90°<θ<−270°, the term will be negative, thus the optical power is decreased. Specifically, for θ=180°, the power is nulled, while, for θ=0°, the power is doubled. These ranges may be generalized to higher orders; they can be periodic with a period of 360°.

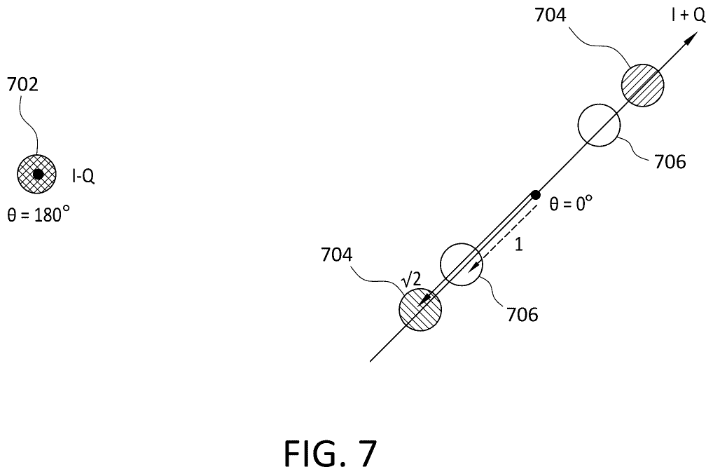

These modes are schematically shown in FIG. 7 as I−Q (I minus Q) mode (left side) and I+Q (I plus Q) mode (right side), respectively. The points coincide in high-suppression mode into a single point 702, while the ASK-2 constellation points obtained in the high-power mode are shown with reference number 704, resulting in an increase in E-field by √2 and thus optical power by (√2)²=2 compared to the QAM-2 points generated in the orthogonal mode 706. (The description here is illustrative. Technically, orthogonal mode generates QAM-2, while high-power mode generates ASK-2, not BPSK.)

Thus, as shown, geometrically, the phase shift between branches of an IQ modulator can be interpreted as the angle between unit vectors spanning the space addressable by the IQ modulator. For θ=90°, two unit vectors will form a Cartesian plane (2-dimensional space, 2D); for θ=0°, a line is formed (1D space); while for θ=180°, a point is formed (OD space). Thus, the operating modes alter the vector space of the optical field at the output of the modulator and for any θ.

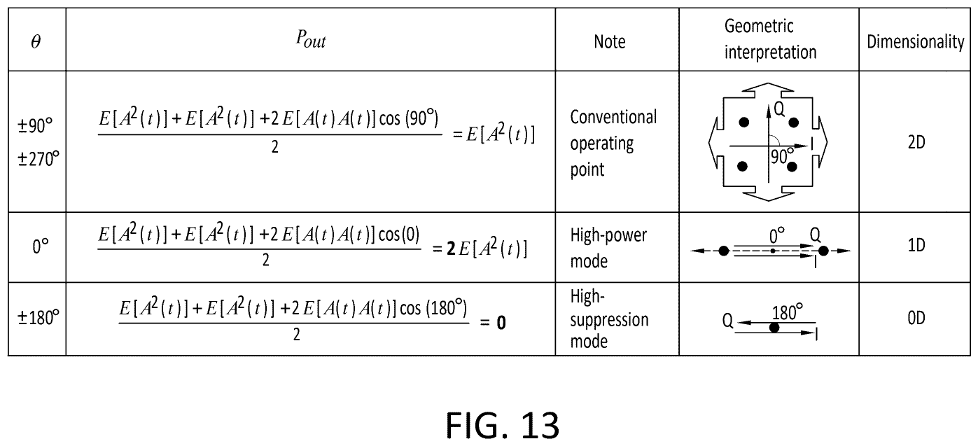

FIG. 13 is a table summarizing these observations and relation to the invented operating modes. The first column shows the phase change θ applied to the IQ modulator. The second column includes the calculation for power of the signal at the output of the IQ modulator after modulation with signals I and Q. The third column identifies the mode of operation (orthogonal/conventional, high-power, high-suppression). The fourth column illustrates the geometric interpretation of the resultant signal. And the las column indicates the dimensionality of the resultant signal.

It is important to observe that in the proposed high-power mode, the optical power is effectively doubled (increased by a factor of 2, or 3 dB, compared to the conventional operating mode), while in the high-suppression mode the optical power is nulled.

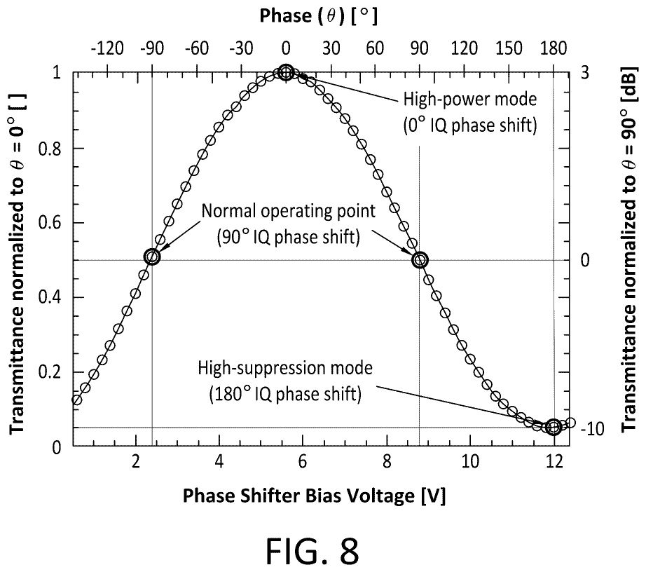

The invented operating modes were experimentally verified by sweeping bias voltage controlling the phase shifter of an optical IQ modulator. Experimental result are shown in FIG. 8, illustrating measured transmittance normalized to θ=0° for phase shift, and also showing the applied phase shift voltage on the bottom.

As shown in the FIG. 8, the normal operating points are at half transmittance, corresponding to 3 dB intrinsic loss from the peak. It is readily visible from FIG. 8 that experimentally, the transmission through the modulator, when normalized to transmission in the conventional operating point, was decreased by 10 dB when in high-suppression mode, θ=±180°, and increased by 3 dB when in high-power mode, θ=0°. This is in line with the theoretical derivation presented above. Any mismatch to ideal theoretical values (−∞ dB and 3 dB, respectively) is due to practical limitations, such as exact amplitude matching between the two inner MZMs in the I and Q branches.

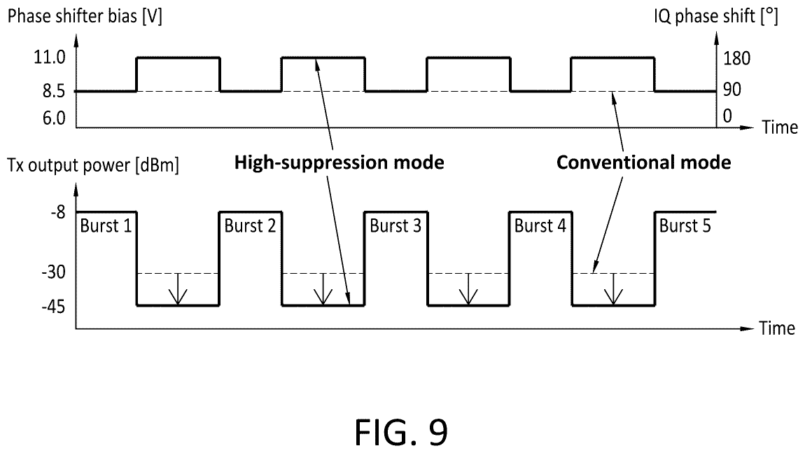

By using an IQ modulator in high-suppression mode, a TDMA or TFDMA PON can be improved by actively suppressing the residual optical carrier, for example, by more than 10 dB in some embodiments, for ONUs that are not transmitting. According to embodiments of the invention, this can be performed in continuous mode at the OLT transmitter, or in burst mode at the ONU transmitter, when ONU is not transmitting the upstream signal, by modulating the phase shifter with a voltage signal synchronized with the emission of bursts. FIG. 9 illustrates an example of a waveform that could be applied to a phase shifter of an IQ modulator for burst-mode operation and the resulting optical power generated from the transmitter.

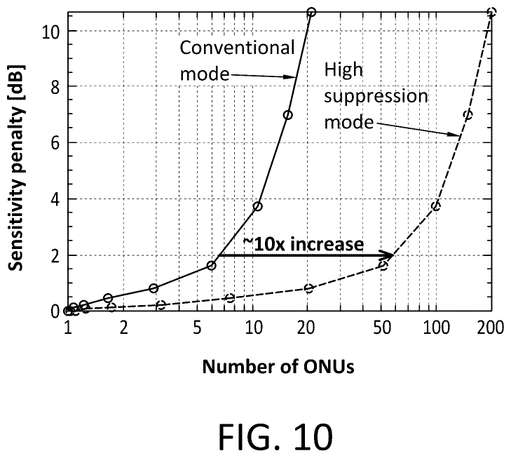

Applying the high-suppression mode to an ODN operating in TDMA or TFDMA, can directly increase the number of ONUs that can be supported in the same ODN. Calculations based on experimental data, shown in FIG. 10, the achievable suppression leads to a 10-fold increase in the number of ONUs that can be supported or more. For example, for 10 dB of suppression and there is a 10× increase in the number of ONUs that can be connected to coherent PON assuming that sensitivity penalty due to crosstalk is limited to 2 dB, as seen in FIG. 10.

Using the modulator in high-power mode may actively increase the transmitter output power by up to 3 dB and thus improve optical power budget. High-power mode can be performed in continuous mode operation at OLT Tx or in burst-mode at ONU Tx or, also in combination with high-suppression mode as shown below.

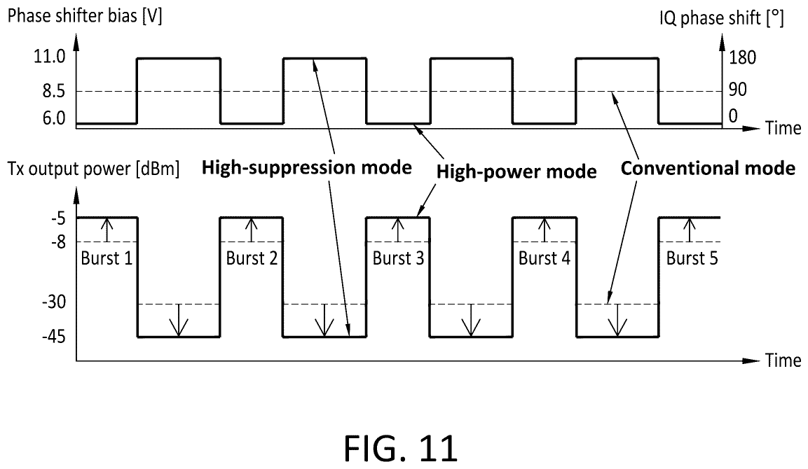

FIG. 11 shows an example of a waveform (top of graph) that could be applied to a phase shifter of an IQ modulator for burst-mode operation, combining high-suppression mode for the off-state and high-power mode for on-state, and the resulting optical power (bottom of graph) generated from the transmitter.

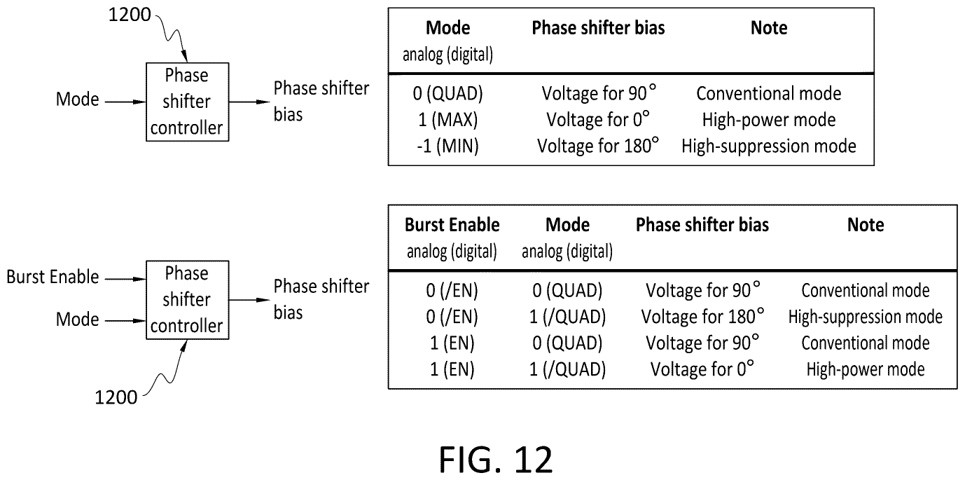

Other implementation examples are shown in FIG. 12. As shown in FIG. 12, a phase shift controller 1200 can be provided that is configured to receive an input signal and to apply a phase shifter bias (voltage or current) to the optical IQ modulator, in order to control the modulator into a conventional mode (typical QPSK orthogonal operation) and into nonorthogonal modes, including the high-suppression mode and the high-power mode. The phase shifter controller can be used for operation in continuous mode (top of FIG. 12) or burst mode (bottom of FIG. 12).

In the continuous example, implementation may be based on a Mode signal, which can be a digital signal (e.g., 00, 01 and 10) or an analog ternary signal. In response, the phase shifter controller may output a voltage level (or current) to control the phase shift of the IQ modulator corresponding to the desired mode of operation.

In the burst-mode controller case, an implementation may be based on a controller accepting a Burst Enable signal, which can be analog or digital binary, and a Mode signal, which can be analog or digital binary signal. Various combinations of the above architectures could be considered.

It will be understood that the controller could be implemented within the ONU circuitry on the user end. ONU circuitry typically includes facilities for generating the burst enable signal. An upstream bandwidth map may be provided for users to conform with by the central office (OLT) for users to conform with, which may send a control to define when burst is to be used. According to an embodiment of the present invention, a first bit can be used to determine when burst mode is present. A second bit may be provided as a mode signal. Configured messaging with central office and user side may also be used.

That is, in conventional PON, the OLT sends information (the upstream bandwidth map) about burst timing (burst start time, allocated duration). According to embodiments of the present invention, the OLT could send the instruction to a particular ONU to employ a nonorthogonal mode, which would then be remembered in the ONU until changed. But in general, an ONU could also make the determination by itself whether to use nonorthogonal mode. For example, the ONU could always use nonorthogonal modes for on- and off-states if possible (i.e., specifically, if the modulation format selected to transmit upstream information is compatible with such mode, that is in case all points in the constellation diagram are collinear and pass through the center), even without explicit instruction from the OLT to do so.

Referring to FIG. 12, block 1200 is not directly controlled by OLT, but rather by an ONU signal defining mode of operation. And mode can be decided by ONU itself or can be overridden by OLT.

A microcontroller (e.g., in the ONU or other device) can be configured to parse the control information from central office to the user side and pass the information to the controller, which is configured to generate a corresponding phase shift bias voltage or current. According to embodiments of the present invention, the controller could be defaulted to high-power mode, for example, to ensure first bursts are sent, but then measurements could be made at central office side and the ONU can be messaged or signalled to reduce power to regular conventional mode based on the measurements.

It will be understood that in high-power mode, which is ASK, there may be a lower data rate, and therefore, the modulator can be controlled to conventional mode when desired to increase data rate. As explained above, it is not necessarily less data rate. QAM-4 orthogonal mode could be replaced with ASK-4 high-power mode and have the same data rate, and still get average power increase. The problem is that minimum Euclidean distance between points will then decrease, which may worsen receiver sensitivity. Less data rate is only in case I and Q branch is driven with the same modulation type in orthogonal and non-orthogonal modes.

As described herein, high suppression mode is particularly suitable to burst mode, and therefore, its preferred implementation is in the ONU. Of course, the invention is applicable to the OLT side as well.

It will be understood that high-power mode is not only applicable to burst mode, but also to apply to continuous transmissions, and therefore, is equally applicable to the central office side (OLT) versus the user side (ONU).

It will be understood that the invented controller can be implemented using known hardware, software, and/or firmware, configured to operate as described herein.

Although specific embodiments of the invention have been described and illustrated, the invention is not to be limited to the specific forms or arrangements of parts so described and illustrated. The scope of the invention is to be defined by the claims appended hereto and their equivalents.

In this description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

What is claimed is:

1. An apparatus, comprising:
an optical IQ modulator configured to generate a complex IQ signal;
a controller coupled with the optical IQ modulator and adapted to control the phase shift (θ) between the in-phase (I) and quadrature (Q) branches of the generated complex IQ signal;
wherein the controller is adapted to control the phase shift of the optical IQ modulator between an orthogonal mode [NB: conventional mode] and a nonorthogonal mode based on an operational state of the optical IQ modulator.

2. The apparatus of claim 1, wherein said nonorthogonal mode includes at least one of a high-power mode and a high-suppression mode.

3. The apparatus of claim 2, wherein the phase shift (θ) between the I and Q branches of said optical IQ modulator is 0 degrees) (θ=0° in said high-power mode and 180 degrees) (θ=±180° in said high-suppression mode.

4. The apparatus of claim 1, wherein said optical IQ modulator is a single-polarization or a dual-polarization optical IQ modulator.

5. The apparatus of claim 2, wherein said controller is adapted to control the optical IQ modulator into said high-suppression mode during a transmitter off-state of the modulator and into one of an orthogonal mode and said high-power mode during a transmitter on-state of the modulator.

6. The apparatus of claim 2, wherein transmission through the modulator, normalized to transmission in a conventional operating point, is decreased in high-suppression mode, and increased when in high-power mode.

7. The apparatus of claim 2, wherein said apparatus is adapted to be implemented within an optical network unit (ONU) coupled with an optical line terminal (OLT) within a Time Division Multiple Access (TDMA) coherent passive optical network (PON); and
wherein said controller is adapted to receive control signals from said OLT and to control said optical IQ modulator the phase shift of the optical IQ modulator based on said received control signals.

8. The apparatus of claim 7, wherein said control signals indicate whether said optical IQ modulator is to be set to the orthogonal mode, the high-suppression mode, or the high-power mode.

9. The apparatus of claim 8, wherein said coherent PON utilize burst-mode transmission to realize upstream channel access and said controller controls said optical IQ modulator to said high-suppression mode is during a burst-disabled mode of said optical IQ modulator by modulating the phase shifter of said optical IQ modulator with a voltage signal synchronized with emission of bursts.

10. The apparatus of claim 2, wherein said apparatus is adapted to be implemented within an optical line terminal (OLT) coupled with a plurality of optical network units (ONUs) within a Time Division Multiple Access (TDMA) coherent passive optical network (PON); and
wherein said control unit is adapted to control said optical IQ modulator the phase shift of the optical IQ modulator for downstream optical transmissions to said plurality of ONUs.

11. A method of power-budgeting within an optical network, comprising steps of:
controlling a phase shift (θ) between an in-phase (I) and quadrature (Q) branches of an optical IQ modulator to generate a complex IQ signal;
wherein the phase shift of the optical IQ modulator is changed between an orthogonal mode [NB: conventional mode] and a nonorthogonal mode based on an operational state of the modulator.

12. The method of claim 11, wherein said nonorthogonal mode includes at least one of a high-power mode and a high-suppression mode.

13. The method of claim 12, wherein the phase shift (θ) between the I and Q branches of said optical IQ modulator is 0 degrees) (θ=0° in said high-power mode and 180 degrees) (θ=±180° in said high-suppression mode.

14. The method of claim 11, wherein said optical IQ modulator is a single-polarization or a dual-polarization optical IQ modulator.

15. The method of claim 12, wherein controlling step controls the optical IQ modulator to said high-suppression mode during an off-state of the modulator and to one of an orthogonal mode and said high-power mode during an on-state of the modulator.

16. The method of claim 12, wherein transmission through the modulator, normalized to transmission in a conventional operating point, is decreased in the high-suppression mode, and increased in the high-power mode.

17. The method of claim 12, wherein said method is performed within an optical network unit (ONU) coupled with an optical line terminal (OLT) within a Time Division Multiple Access (TDMA) coherent passive optical network (PON); and
wherein said controlling step is based on control signals from said OLT.

18. The method of claim 18, wherein said control signals indicate whether said optical IQ modulator is to be set to the orthogonal mode, the high-suppression mode, or the high-power mode.

19. The method of claim 19, wherein said high-suppression mode is during a burst-disabled mode.

20. The method of claim 12, wherein said method is performed within an optical line terminal (OLT) coupled with a plurality of optical network units (ONUs) within a Time Division Multiple Access (TDMA) coherent passive optical network (PON); and
wherein said controlling step controls said optical IQ modulator the phase shift of the optical IQ modulator for down-stream optical transmissions to said plurality of ONUs.
